(19) United States
(12) Patent Application Publication
(10) Pub. No.: US 2007/0079181 A1
(43) Pub. Date: Apr. 5, 2007

(54) Modified linear congruence interleaver and its parameter selection method

(75) Inventor: Jung-pil Yu, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/416,249

(22) Filed: May 3, 2006

(30) Foreign Application Priority Data
Sep. 15, 2005 (KR) 2005-86256

(51) Int. Cl. G06F 11/00

(52) U.S. Cl. 714/701

(57) ABSTRACT

A parameter selection method and a modified linear congruence interleaver are provided. The parameter selection method of the linear congruence interleaver includes the operations of: determining a placement zone corresponding to index values generated by an algorithm; determining position values (i₁, i₂) of groups of data including corresponding index values among the generated index values in the placement zone; and determining a parameter value Dₖ, wherein Dₖ=P(Qi₁+i₂−k)(mod L). Therefore, the time can be reduced which is required to search an optimized interleaver.

### CROSS-REFERENCE TO RELATED APPLICATIONS

This application claims the benefit of Korean Application No. 2005-86256, filed Sep. 15, 2005, in the Korean Intellectual Property Office, the disclosure of which is incorporated herein by reference.

### BACKGROUND OF THE INVENTION

1. Field of the Invention

Aspects of the invention relate to a modified linear congruence interleaver and its parameter selection method. More particularly, aspects of the invention relate to a parameter selection method to generate feasible cases for a linear congruence interleaver applying to an iterative decoder and to a modified linear congruence interleaver.

2. Description of the Related Art

In modern communication circuit, an interleaver is widely used. The interleaver is a device to arrange data transmitted from a transmitter so that data are not in the vicinity of one another. When the interleaver is properly utilized, a burst error, which occurs in a noisy environment, is changed to a random error, so that a channel modulator can have an improved performance. The burst error is an error type in which a general error pattern in a data communication environment concentrates and generally occurs in a certain position.

When used for an iterative decoder such as Turbo code, the interleaver accelerates the convergence of the iterative decoder so as to improve the demodulating performance. However, as the size of interleaver increases, the memory size also increases to store the position of the interleaver. The increase of memory size may be a big problem although the iterative decoder has an improved performance.

To address the problem of memory size, a parametric interleaver can be utilized. The parametric interleaver can define a certain interleaving structure with several parameters. Interleaving positions that are possible are calculated on the fly from the structure and parameters. The structure is often based on linear congruence expressions. The number of parameters is generally quite smaller than the interleaver size for two reasons. One reason is to alleviate the memory size requirement and the other reason is to facilitate the parameter optimization.

The parametric interleaver typically has a low implementation complexity and can be easily reconfigurable for different interleaving sizes by changing parameters. Therefore, an algorithm is typically required to configure a parametric linear congruence intereleaver suitable for an iterative decoder and to search optimized parameters when configuring the parametric linear congruence interleaver.

### SUMMARY OF THE INVENTION

Several aspects and example embodiments of the invention promote resolving and addressing the drawbacks, as described, and other problems associated with arranging data transmitted from a transmitter so that data are not in the vicinity of one another. In this regard, an aspect, among aspects, of the invention is to provide a parameter selection method to configure a parametric linear congruence interleaver suitable for an iterative decoder and to select an optimized parameter, and another aspect, among aspects of the invention, is to provide a linear congruence interleaver thereof to select an optimized parameter to arrange data transmitted from a transmitter, wherein the data are not in the vicinity of one another.

In order to achieve the above-described aspects and/or other aspects and features of the invention, there is provided a parameter selection method of a linear congruence interleaver to interleave input data by k linear equations, the method including the operations of: determining a placement zone specified by index values, such as generated by an algorithm; determining position values (i₁, i₂) of groups of the data including a number of, index values among the generated index values in the placement zone; and calculating, or determining, a parameter value Dₖ for use in an interleaving operation of the input data based on the equation:

Dₖ=P(Qi₁+i₂−k)(mod L), wherein L indicates a length of the data to interleave, Q indicates a number of the linear congruence equations, and k has a value in a range of 1 through Q−1, P indicates a parameter, with P and L being relatively prime to each other in a relation of a greatest common divisor (gcd) (P, L), and i indicates an index value of the input data corresponding to the position values (i₁, i₂).

The operation of determining position values (i₁, i₂) of groups of the data including a number of index values among the index values in the placement zone can include: determining a respective number and a respective length of the groups of the data; forming groups of the data corresponding to the respective number and the respective length in the placement zone; and determining the position values (i₁, i₂) for the groups of the data.

Also, according to further aspects among other aspects and/or other features of the invention, there is provided a linear congruence interleaver to interleave input data by k linear equations including: a placement determiner to determine a placement zone specified by index values, such as generated by an algorithm; a position value determiner to determine position values (i₁, i₂) of groups of the data including a number of index values among the generated index values in the placement zone, and a parameter selector to determine, or calculate, a parameter value Dₖ for use in an interleaving operation of the input data based on the following equation: Dₖ=P(Qi₁+i₂−k)(mod L), and an interleaving unit to interleave the input data by the k linear equations using the determined parameter value Dₖ, wherein L indicates a length of data to interleave, Q indicates a number of linear congruence equations, k has a value in a range of 1 through Q−1, P indicates a parameter, with P and L being relatively prime to each other in a relation of a greatest common divisor (gcd) (P,L), and i indicates an index value of input data of the input data corresponding to the position values (i₁, i₂).

The position value determiner can determine the respective number and a respective length of the groups of the data, can form groups of data corresponding to the respective number and the respective length in the placement zone, and can determine the position value (i₁, i₂) for the groups of the data.

Aspects and embodiments also provide a linear congruence interleaver to interleave input data for use in an interleaving operation of the input data, based on the following equation: pi(i)=(P*i+D_{i mod Q}) mod L, wherein L is the interleaving length, and P, D_0, . . . , D_{Q−1} are the integer parameters. According to aspects of the invention, in the equation pi(i)=(P*i+D_(i mod Q))mod L, the i-th symbol in the input block of the data is placed in the pi(i)-th symbol in the interleaved block of the data.

Aspects and embodiments also provide a parameter selection method of a linear congruence interleaver, the method including: interleaving input data by a linear congruence interleaver for use in an interleaving operation, based on the following equation: pi(i)=(P*i+D_{i mod Q}) mod L, wherein L is the interleaving length, and P, D_0, . . . , D_{Q−1} are the integer parameters. According to aspects of the invention, in the interleaving functional relation pi(i)=(P*i+D_(i mod Q))mod L, the i-th symbol in the input block of the data is placed in the pi(i)-th symbol in the interleaved block of the data.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a block diagram of a modified linear congruence interleaver according to an example embodiment of the present invention;

FIG. 1B is a block diagram of an Advanced Television System Committee (ATSC)/Vestigial SideBand (VSB) transmission system incorporating the modified linear congruence interleaver of FIG. 1A, for data transmission, according to an example embodiment and aspects of the invention;

FIG. 1C is a block diagram turbo post-processor incorporating the modified linear congruence interleaver of FIG. 1A included in the ATSC/VSB transmssion system of FIG. 1B according to an example embodiment and aspects of the invention;

FIG. 2 is a flowchart for explaining a parameter selection method of a modified linear congruence interleaver according to an example embodiment and aspects of the invention;

FIGS. 3A through 3E are views to explain and illustrate example placement zones and groups depending on parameters according to aspects of the invention;

FIG. 4 is a view illustrating pseudo code applying to aspects of the invention; and

FIGS. 5A and 5B are graphs illustrating simulation results of various interleavers to illustrate aspects of the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

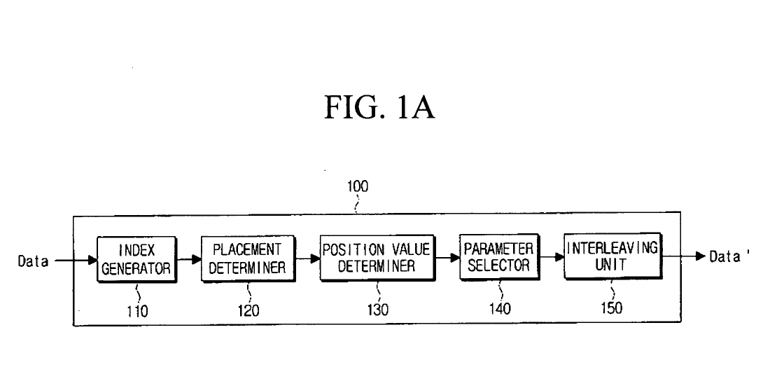

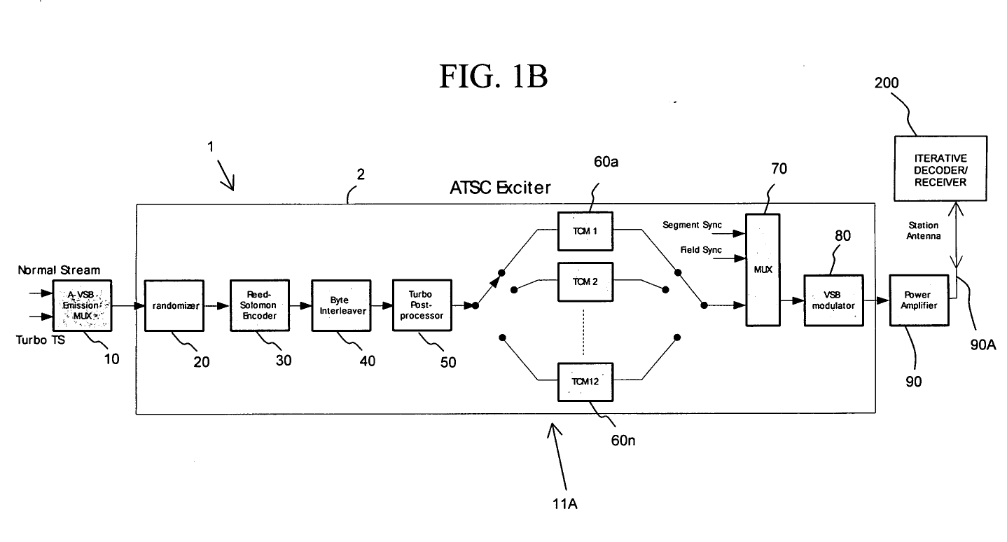

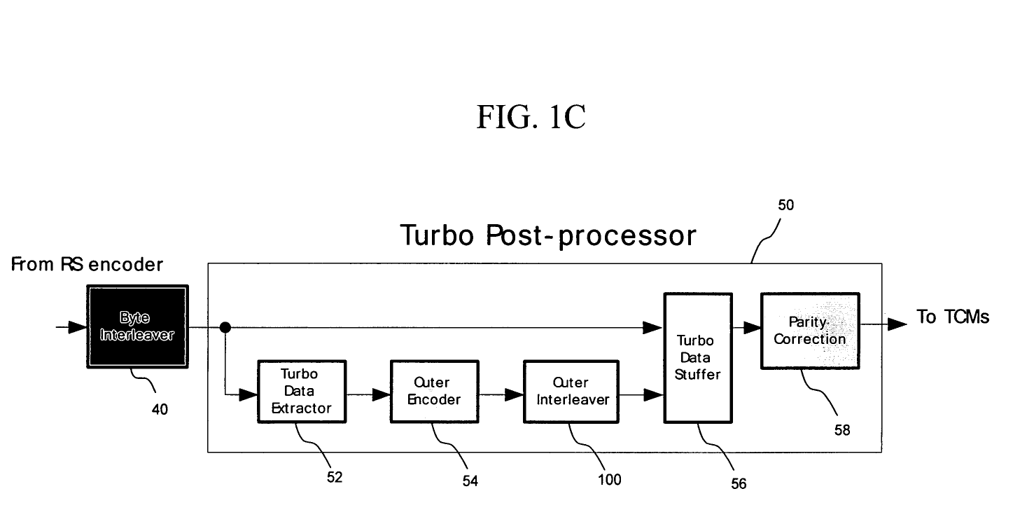

FIG. 1A is a block diagram of a modified linear congruence interleaver 100 according to an example embodiment of the present invention. Referring to FIG. 1, the linear congruence interleaver 100 according to an example embodiment and aspects of the invention includes an index generator 110, a placement determiner 120, a position value determiner 130, a parameter selector 140, and an interleaving unit 150.

The index generator 110 generates index values by a linear congruence interleaver that interleaves input data. The linear congruence interleaver 100 according to an example embodiment of the present invention is expressed in Equation 1 as follows:
π₀(i)=P×i+Dₖ(mod L) Equation 1
where, i indicates an index value of a placement zone, L indicates a length of data to be interleaved, P being a parameter, with P and L being relatively prime to each other, and k is a value in a range of 1 to L−1.

Also, the linear congruence interleaver 100, according to aspects of the invention, can be represented by a set of linear congruential expressions and expressed as:
Π(i)=P·i+D_{k(mod Q)} (mod L)
In this regard, the interleaving rule typically can have Q+1 parameters (P, D0, D1, . . . , D_{Q-1}) to be determined so to promote improving the performance. Typically, these parameters lie in the integral range of [0, L−1]. However, all values in this range do not necessarily generate valid interleavers. Therefore, it can be helpful to know the parameter properties which provide valid solutions to promote reducing the later optimization time by eliminating parameter combinations in advance. For example, to illustrate in simplest form, where Q is equal to 1, the above expression Π(i)=P·i+D_{k(mod Q)}(mod L) becomes Π(i)=P·i+D₀(mod L). This is the circular shifted version of the linear congruential interleaver Π(i)=P·i(mod L) [2] [4]. Also, an inteleaver typically is a feasible interleaver if the output values of the interleaving function Π(i) (i=0, . . . , L−1) is a permutation of the integers 0, . . . , L−1, for example.

The placement determiner 120 determines a placement zone specified by index values generated by the index generator 110, such as being generated by a suitable algorithm. The position value determiner 130 determines each position value i₁ (column value) and i₂ (row value) of groups including a certain number of index values among the index values generated by the index generator 110 in the placement zone selected by the placement determiner 120. The position values of the groups of data indicate the first index value of the corresponding group of the data.

The parameter selector 140 calculates, or determines, a parameter Dₖ by Equation 2 as follows:
Dₖ=P(Qi₁+i₂−k)(mod L) Equation 2

In Equation 2, L indicates a length of data to be interleaved, Q indicates the number of linear congruence equations, k has a value in a range of 1 through Q−1, P is a parameter, with P and L being in a relation to satisfy the relation of a greatest common divisor (gcd) (P, L), that is, relatively prime to each other, and i indicates an index value of the input data. The interleaving unit 150 performs interleaving by parameter Dₖ selected by the parameter selector 140 and outputs the interleaved and modified data.

Also, the linear congruence interleaver 100, including the index generator 110, the placement determiner 120, the position value determiner 130, the parameter selector 140, and the interleaving unit 150, in selecting an optimized parameter or parameters, according to an example embodiment and aspects of the invention, can interleave the input data for use in an interleaving operation of the input data, based on the following equation: pi(i)=(P*i+D_{i mod Q}) mod L, wherein L is the interleaving length, and P, D_0, . . . , D_{Q−1} are the integer parameters. According to aspects of the invention, in the equation pi(i)=(P*i+D_(i mod Q))mod L, the i-th symbol in the input block of the data is placed in the pi(i)-th symbol in the interleaved block of the data. Also, according to aspects of the invention the linear congruence interleaver 100 implements a parameter selection method interleaving the input data based on the equation pi(i)=(P*i+D_{i mod Q}) mod L to interleave the input data.

Aspects of the invention as to the parameter selection methods and linear congruence interleavers can also be embodied as computer-readable code in a computer-readable medium, such as for execution by a processor. Examples of a computer-readable medium include read-only memory (ROM), random-access memory (RAM), magnetic storage media (e.g., floppy discs, hard discs, etc.), optical storage media (e.g., CD-ROMs, DVDs, etc.) and carrier waves (e.g., transmissions over the Internet). The computer-readable medium may also be distributed over network-coupled computer systems so that the computer-readable code is stored and executed in a distributed fashion. Functional programs, code, and code segments for implementing aspects of the invention can be easily constructed by programmers skilled in the art to which the invention pertains.

Also, according to aspects of the invention, the components of the linear congruence interleaver 100 according to aspects of the invention including the index generator 110, the placement determiner 120, the position value determiner 130, the parameter selector 140, and the interleaving unit 150 can be implemented be any suitable processing device, such as a processor, microprocessor or an application specific integrated circuit (ASIC), with associated memory and software or programming, as well as various components of the ATSC/VSB transmission system 1.

FIG. 1B is a block diagram of the ATSC/VSB transmission system 1 and an example digital broadcasting system 11A to transmit/receive data, incorporating the modified linear congruence interleaver 100 of FIG. 1A, for data transmission to an iterative decoder/receiver 200, according to an example embodiment and aspects of the invention. The ATSC/VSB transmission system 1 includes an exciter 2 to generate a transport stream (TS) including a normal stream and a Turbo stream in the form of packets. The ATSC emission MUX 10 can receive a normal stream and a Turbo stream. Then the ATSC emission MUX 10 assembles deterministic frames for the Turbo stream and inserts the placeholders for Turbo data, such as which can serve as containers for redundant bits to be generated by the outer encoder in the Turbo post-processor 50.

In the randomizer 20, packets in the frames are randomized and then encoded in the Reed-Solomon (RS) encoder 30. After byte interleaving in the byte interleaver 40, the packets are manipulated in the turbo post-processor 50. After being processed in the Trellis-Coded Modulation (TCM) encoder block 60a to 60n, the packets are then combined with data field synchronization (sync) and segment sync symbols in a multiplexer 70 to form a Vestigial SideBand (VSB) frame. The VSB frame is then modulated for transmission by the VSB modulator 80. The VSB modulated frame is amplified for transmission, such as by a power amplifier 90 and then transmitted, such as through an antenna 90a to a receiver, such as the iterative decoder/receiver 200. The digital broadcast system 11A includes the ATSC/VSB transmission system 1 and the iterative decoder/receiver 200 included as part of an ATSC/VSB reception system that receives the transmitted data from the ATSC/VSB transmission system 1, according to aspects of the invention, and the invention is not limited in this regard.

FIG. 1C is a block diagram of the turbo post-processor 50 incorporating the modified linear congruence interleaver 100 of FIG. 1A in the ATSC/VSB transmission system 1 of FIG. 1B according to an example embodiment and aspects of the invention. In this regard, the Turbo post-processor 50 touches only Turbo data bytes. Turbo data is extracted in the Turbo data extractor 52. Placeholders in a Turbo data byte are filled with the outer encoder's redundancy bits and Turbo data and are interleaved in the outer linear congruence interleaver 100, typically bit by bit. The Turbo data stuffer 56 puts the processed Turbo data in place. Since the Turbo data placeholders are filled in the turbo data stuffer 56, the RS parity bytes attached in the previous block are not correct any longer. These no longer valid parity bytes are corrected in the parity correction corrector 58.

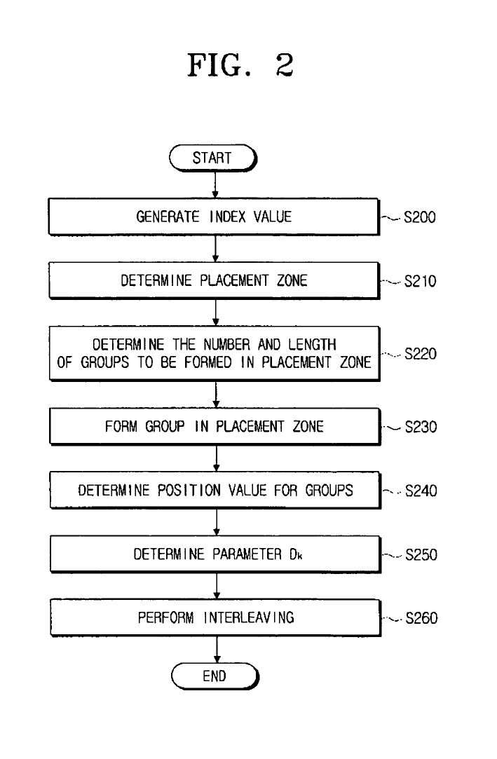

FIG. 2 is a flowchart to explain a parameter selection method of a linear congruence interleaver according to an example embodiment and aspects of the invention. The linear congruence interleaver's parameter selection method will be described with reference to FIGS. 1A through 2. If data is input to the linear congruence interleaver 100, before transmitting data from a transmitter of the ATSC/VSB transmission system 1, to the receiver, such as the iterative decoder/receiver 200, the index generator 110 generates index values by the linear congruence interleaver 100, such as in Equation 1, as described (operation S200).

If the index values are generated by the index generator 110, the placement determiner 120 determines a placement zone specified by index values generated by the index generator 110 (operation S210). If the placement zone is determined by the placement determiner 120, the position value determiner 130 determines the number of groups of data to be formed in the placement zone and the lengths of each group of data to determine the position value of leading value (operation S220).

The position value determiner 130 determines the number and the length of groups of data, and then the position value determiner 130 forms groups of data to correspond to each number and length of groups of data pre-determined in the placement zone (operation S230), and determines the position value, that is, i₁ and i₂, of the leading value for the formed groups of data (operation S240). If the position value is determined by the position value determiner 130, the parameter selector 140 determines parameter Dₖ using Equation 2, as described (operation S250). If the parameter Dₖ is determined by the parameter selector 140, the interleaving unit 150 performs interleaving for data using Dₖ so that interleaved and modified data are output (operation S260).

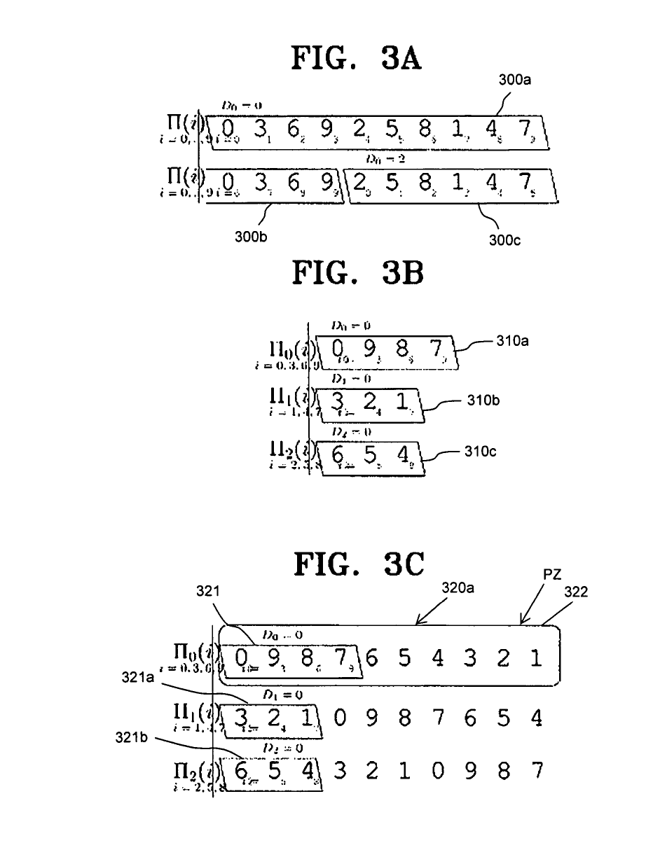

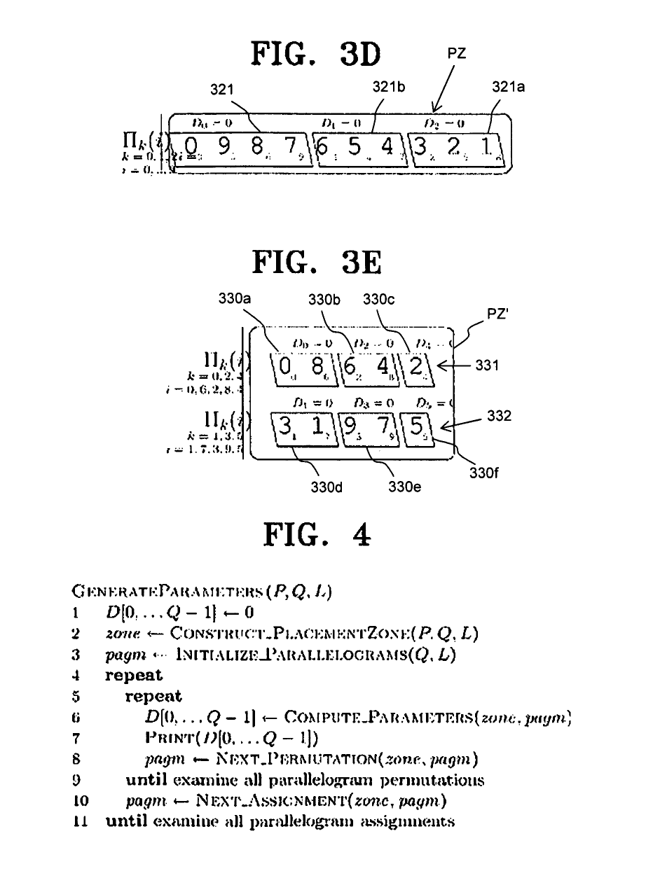

FIGS. 3A through 3E are views to explaining the placement zone and groups depending on parameters, according to aspects of the invention. A method to determine index values by using an assumed value, for example, in the linear congruence equation (Equation 1), according to aspects of the invention, is explained as follow. In this regard, assume k=0, L=10, and P=3, and Equation 1 can be expressed in equation 3 as follows:
π(i)=3×i+D₀(mod10) Equation 3

If values of D₀ are changed into those in a range of 0 through 9 and applied to equation 3, π(i) is calculated in order of 0, 3, 6, 9, 2, 5, 8, 1, 4, 7. FIG. 3A illustrates two cases in the example with D₀=0, and D₀=2. The portions surrounded by the parallelograms 300a, 300b and 300c in FIG. 3A are groups.

Continuing with the example, in the case of P=3, L=10, and k=3, there are 3 parameters. Therefore, the interleavers can be expressed in Equation 4 as follows:
π(i)=
π₀(i)=3×i+D₀(mod10)=0,3,6,9
π₁(i)=3×i+D₁(mod10)=1,4,7
π₂(i)=3×i+D₂(mod10)=2,5,8 Equation 4
The interleaving positions by equation 4 are depicted in FIG. 3B, by the groups 310a, 310b and 310c. As shown in FIG. 3B, each group of all rows do not necessarily have the same length.

Continuing with reference to FIG. 3C, each row can be extended to the same length by repeating the interleaving positions, as depicted in FIG. 3C. The first row 320a of FIG. 3C can be considered as a playground in which all the groups can be moved. When the group indicated as a parallelogram 321 at the first row is surrounded with a rounded square 322 as in the example illustration in FIG. 3C, there is indicated a placement zone PZ.

Since there is no superposition among the parallelograms, three parameters D₀=1, D₁=0, D₂=0 define a feasible interleaver. In this case, the number of feasible interleavers is thus the number of ways of putting 3 parallelograms, such as parallelograms 321, 321a and 321b in the placement zone PZ without any superposition. In a first operation, there are 10 possibilities for placing one of three parallelograms and then 2! possibilities for completing the uncovered region with the other parallelograms. This combinatorial reasoning gives 10×2!=20. This is depicted in FIG. 3D, which illustrates the parallelograms 321, 321a, 321b being placed in the placement zone PZ without any superposition. Considering all possible 3 parameter combinations which are 103=1000, the knowledge of the feasible interleavers, according to aspects of the invention, can considerably reduce the search effort to find good, or optimum, parameter combinations. Typically, only 2 percent of all parameter combinations provide feasible interleavers.

As another example according to aspects of the invention, the placement zone description of the interleaver with Dᵢ=0(i∈{0, . . . ,5}) is depicted in FIG. 3E. As illustrated in FIG. 3E, there are 6 parallelograms, 330a, 330b, 330c, 330d, 330e, and 330f positioned in the placement zone PZ′. Each row 331, 332 in the example illustration has 2 long and 1 short parallelograms, with the two long parallelograms 330a and 330b and the one short parallelogram 330c in row 331 and with the two long parallelograms 330d and 330e and the one short parallelogram 330f in row 332. In this regard, typically only 0.12 percent of all possible combinations result in feasible interleavers.

The following discussion, is offered to illustrate and demonstrate that the parameter selection methods and apparatus, according to the several example embodiments and aspects of the invention, provide linear congruence interleavers and parameter selection methods that utilizing a geometric algorithm to generate feasible, or optimized, interleavers, where the time can be reduced which is required to search an optimized interleaver. In this regard, the placement zone, such as the placement zones PZ and PZ′, for example, can be defined by the aforementioned interleaving algorithm of Equation 1.

Therefore defining, as Definition 1, a placement zone, such as the placement zones PZ and PZ′, by an interleaving rule (Equation 1) indicates a table with c row and I columns where c=gcd (Q, L) and l=L/C. Each element of the placement zone is indicated by Equation 5.
π(Qi₁+i₂)|_{allD(.)}=0, Equation 5
where i₁ and i₂ are column and row indexes respectively.

In that the placement zone, in the example discussion, has only one copy of interleaving positions, the following Proposition 1 is offered. Proposition 1 is that Q=qc, L=lc, c=gcd (Q,L), and the modulo function π(i₁, i₂)=Qi₁+i₂ (mod L) forms a complete set of residues {0, 1, . . . , L−1}(modulo L) for i₁∈{0, . . . , l−1} and i₂∈{0, . . . , c−1}.

The proof offered as to Proposition 1 is that from the range of i₁ and i₂, the total number of π(i₁, i₂) is lc=L and 0≦π(i₁, i₂)<L. Therefore, if all L values of π(i₁, i₂) are distinct, π(i₁, i₂) forms a complete set of residues modulo L. In this regard, for example, assume that there exist two pairs of (i₁, i₂) which are (a₁, a₂), (b₁, b₂) with 0≦a₁, b₁<1, 0≦a₂, b₂<c and (a₁, b₁)≠(a₂, b₂) such that π(a₁, a₂)=π(b₁, b₂). Therefore, from the definition of modulo and π(i₁, i₂), Equation 6 can be written.

$$π ( {a}_{1} , {a}_{2} ) = π ( {b}_{1} , {b}_{2} ) \\ {Qa}_{1} + {a}_{2} = {Qb}_{1} + {b}_{2} ( mod L ) \\ Q ( {a}_{1} - {b}_{1} ) + ( {a}_{2} - {b}_{2} ) = kL \\ for a certain integer k \\ q ( {a}_{1} - {b}_{1} ) + \frac{{a}_{2} - {b}_{2}}{c} = kl \qquad Equation 6$$

Since −c<a₂−b₂<c, a₂ must be b₂. Equation 6 becomes qa₁−qb₁=kl. From gcd (q, l)=1, a₁=b₁ mod l. Also, since a₁, b₁ are the least residues (0≦a₁, b₁<l), a₁ must be b₁. In that these results violate the assumption of (a₁, b₁)≠(a₂, b₂), all L values of π(i₁, i₂) are distinct and the proof is competed.

Continuing, in view of the foregoing, the following Theorem 1 is now offered. Theorem 1 is that the placement zone by an interleaving rule (Equation 1) contains only one copy of interleaving positions. In proving Theorem 1, gcd(P, L)=1 makes sure that Π(i)|_{allD}_{_{(.)}}₌₀ defines a feasible interleaver for i∈{0, 1, . . . , L−1}, and Qi₁+i₂ (mod L) produces a complete set of residues {0, 1, . . . , L−1} for given i₁ and i₂ ranges. Thus, the placement zone, such as the placement zones PZ and PZ′, with its elements defined by Equation 5, contains only one copy of interleaving positions of a feasible interleaver, and the proof is completed.

In a placement zone, such as the placement zones PZ and PZ′, parallelograms must be put without superposition. There are two different lengths of parallelograms which are

$$⌊ \frac{L}{Q} ⌋ + 1 = ⌊ \frac{l}{q} ⌋ + 1 and ⌊ \frac{L}{Q} ⌋ = ⌊ \frac{l}{q} ⌋ .$$

In this regard, there are L (mod Q) number of long parallelograms and Q−(L (mod Q)) number of short parallelograms. The total number of feasible interleavers in a general closed form therefore must be derived. In order to do that, the two occasion numbers, for example, should be computed in a placement zone, such as the placement zone PZ or PZ′. In this regard, some groups are assigned in the form of parallelograms to cover each row without any superposition, and the groups in the form of parallelograms are permutated at each row.

When some parallelograms are assigned to each row in a placement zone, the sum of their lengths has to be equal to the row length to cover the row without any superposition. In this regard, the problem can appear complicated because there are generally two different lengths of parallelograms. Therefore, in the example discussion, a definition of a regular placement condition is offered. Defining a regular placement condition, as Definition 2, indicates that two different lengths of parallelograms are equally assigned to each row in a placement zone. In other words, for example, each row is covered by the same number of long parallelograms and the same number of short parallelograms in the placement zone.

Therefore, in this regard, Lemma 1 is offered that the regular placement condition makes sure that all rows are covered by some parallelograms without any superposition among them. As to proving Lemma 1, it should be shown that the total length of parallelograms at each row is equal to the row length of zone. In this regard, Q=qc, L=lc (c=gcd(Q, L)) and L (mod Q)=lc (mod qc)=xc, where x is a certain integer in {0, . . . , q−1} In this regard, l (mod q)=x. Therefore, in a placement zone, such as placement zones PZ or pZ′, L (mod Q)=xc parallelograms of length

$$⌊ \frac{l}{q} ⌋ + 1$$

and Q−(L (mod Q))=qc−xc parallelograms of length

$$⌊ \frac{l}{q} ⌋$$

are available. Since the placement zone has c number of rows, the regular placement condition imposes on each row, x number of long parallelograms and q−x number of short parallelograms. Thus, the total length of parallelograms in each row is indicated by Equation 7.

$$x ( ⌊ \frac{l}{q} ⌋ + 1 ) + ( q - x ) ⌊ \frac{l}{q} ⌋ = x + q ⌊ \frac{l}{q} ⌋ \qquad Equation 7 ]$$

Since x=l (mod q), Equation 7 becomes l which is the length of each row, and the proof is completed.

Also, there can be feasible interleavers not meeting the regular placement condition, and in this regard, the regular placement condition typically does not limit the parameters space in practical cases of small Q values.

Continuing, in view of the foregoing, the result by computing, or determining, the two occasion numbers, previously mentioned, can be stated as Theorem 2 which indicates that with an interleaving rule (Equation 1), the number of feasible interleavers is given by equation 8 under the regular placement condition.

$${\{ \frac{l}{q} ( \begin{matrix}q \\ x\end{matrix} ) \}}^{c} ( xc ) ! ( ( q - x ) c ) ! , \\ where c = gcd ( L , Q ) , q = Q / c , \\ l = L / c and x = l ( mod q ) . \qquad [ Equation 8 ]$$

To prove Theorem 2, the ways to assign the parallelograms should be considered. For example, for the first row in a placement zone, such as the placement zones PZ or PZ′, x ones from xc number of long parallelograms and q−x ones from (q−z)c number of short parallelograms are chosen. Thus, the occasion number for the first row in a placement zone is indicated as

$$( \begin{matrix}xc \\ x\end{matrix} ) ( \begin{matrix}( q - x ) c \\ q - x\end{matrix} ) .$$

Similarly, for the second row in a placement zone, the occasion number for the second row in a placement zone is indicated as

$$( \begin{matrix}xc - x \\ x\end{matrix} ) ( \begin{matrix}( q - x ) c - ( q - x ) \\ q - x\end{matrix} ) .$$

The iterative operation is continued to choose the corresponding occasion number until all parallelograms are assigned to rows. The total number of combination is therefore the product of all occasion numbers as indicated by Equation 9 as follows:

$${\prod }_{k = 0}^{c - 1} ( \begin{matrix}x ( c - k ) \\ x\end{matrix} ) ( \begin{matrix}( q - x ) ( c - k ) \\ q - x\end{matrix} ) \qquad [ Equation 9 ]$$

Then, since there are q parallelograms in a row and c rows in a placement zone, the total number of permutation of all rows is indicated as in Equation 10 as follows:
(l(q−1)!)^{c} [Equation 10]
Therefore, from Equations 9 and 10, the number of feasible interleavers is indicated as in Equation 11 as follows:

$${( l ( q - 1 ) ! )}^{c} {\prod }_{k = 0}^{c - 1} ( \begin{matrix}x ( c - k ) \\ x\end{matrix} ) ( \begin{matrix}( q - x ) ( c - k ) \\ q - x\end{matrix} ) \qquad [ Equation 11 ]$$

FIG. 4 depicts the pseudo code according to an example embodiment and aspects of the invention, such as implemented by the 11 operations of the example searching algorithm illustrated in FIG. 4 to generate the parameters P, Q, and L.

Also, assuming that interleaver parameters have a substantially reduced search space, it is typically necessary to discern proper parameters among the parameters. In this regard, the parallelogram assignment to rows and the row permutation can be done in combination and permutation functions of a computer program, for example.

As to operation 8 in FIG. 4, as to the D_{(.)} parameter computation Dₖ, it can be assumed, for example, that the parallelogram related to Dₖ is placed somewhere and the position of its leading edge is i₂ row and i₁ column in a placement zone, and Dₖ can be indicated or expressed as by Equation 12, as follows:
Pk+Dₖ=P(Qi₁+i₂)(mod L) [Equation 12]
Therefore, according to aspects of the invention, all Dₖ from the leading edge position (i₁, i₂) of the parallelogram corresponding to Dₖ can be determined or computed.

Where the induced interleaver parameters are calculated, or determined, it is typically necessary to discern good or optimal parameters among the parameters. In this regard, the interleaver quality with the given parameters has to be evaluated. In the evaluation of the parameters, typically there are two generally accepted criteria.

One of the two criteria is to examine the cycle distribution in a code graph (reference material: J. Yu, M.-L. Boucheret, R. Vallet, G. Mesnager, and A. Duverdier, “Interleaver design for turbo codes from convergence analysis,” accepted to appear in IEEE Transactions on Communications, the disclosure of which is incorporated herein by reference). For example, a cost function depending on a cycle distribution is defined. In the above reference material, a cost function was proposed based on the message flow on graph. In short, it is a weighted sum of cycle lengths, and the weights depend on environmental factors, such as encoder types, puncturing patterns, and channel noise level. However, this cycle distribution can be less practical because these factors are liable to change.

The other of the two criteria is to investigate a code weight distribution. The error bounding technique relates the performance with the weight distribution (reference material: R. G. Gallager, Information Theory and Reliable Communication. 1 em plus 0.5 em minus 0.4 em, Wiley, John & Sons, 1968, and reference material: D. Divsalar, “A simple tight bound on error probability of block codes with application to turbo codes,” in TMP Progress Report. 1 em plus 0.5 em minus 0.4 em JPL, November 1999, the disclosures of which are incorporated herein by reference). Berrou and al. proposed a simple algorithm of examining the weight distribution (reference material: C. Berrou and S. Vaton, “Computing the minimum distances of linear codes by the error impulse method,” in ISIT 2002, Lausanne, Switzerland, June 2002, p. 5, the disclosure of which is incorporated herein by reference). However, this proposed examining of the weight distribution can nonetheless be a considerable task in relation to verifying the weight distribution of many interleaver candidates.

In this regard, the most practical and simplest method can be in relation to the shortest cycle and its multiplicity in an interleaver with given parameters, which is based on the same construction principle as the spread (S)-random interleaver. The S-random interleaver with s parameter typically guarantees the shortest cycle of the length s+1 (reference material: S. Dolinar and D. Divsalar, “Weight distributions for turbo codes using random and nonrandom permutations,” in TDA Progress Report, ser. 42.1 em plus 0.5 em minus 0.4 em JPL, August 1995, vol. 122, pp. 56-65, the disclosure of which is incorporated herein by reference).

A support tree with a fixed window size can be also examined in relation to the criteria (reference materials: N. Wiberg, “Codes and decoding on general graphs,” PhD dissertation, Linköping University, Linköping, Sweden, 1996; R. G. Gallager, Low-Density Parity-Check Codes. 1 em plus 0.5 em minus 0.4 em Cambridge, Mass.: MIT press, 1963; and E. A. Gelblum, A. R. Calderbank, and J. Boutros, “Understanding serially concatenated codes from a support tree approach,” in Proceedings of the International Symposium on Turbo Codes and Related Topics, Brest, France, September 1997, pp. 271-274, the disclosures of which are incorporated herein by reference). Exploring a support tree from the root to low level, it can be seen the same nodes typically are used several times due to the finite number of nodes. The independent support tree depth t_{depth} is defined as a positive integer number such that the nodes from the root to the t_{depth} level are distinct. In order to increase the number of independent iterations, it is desirable to have a relative large t_{depth} value.

As previously stated, the entire contents and disclosures of the reference materials mentioned above are incorporated herein by reference as a part of the present application.

An interleaver design example for Turbo codes is explained, for example, with reference to the s-value and t_{depth} criteria (the fixed window size 3) being used as an interleaver quality measure. In simulations, quadrature phase shift keying (QPSK) with the coherent demodulation with perfect carrier synchronization is used with 512 message bits and 1/3 code rate, for example. The generator polynomial of the constituent encoder is (1, 17/15)₈ in octal form. Also, an adaptive (average) white Gaussian noise (AWGN) channel without inter-symbol interferences is assumed. Tail-biting encoding (reference material: C. Weiβ, C. Bettstetter, and S. Riedel, “Code construction and decoding of parallel concatenated tail-biting codes,” IEEE Transactions on Information Theory, vol. 47, no. 1, pp. 366-386, January 2001, the disclosure of which is incorporated herein by reference) and the Min-Sum algorithm are used as single input, single output (SISO) decoding.

In this regard, an S-random interleaver is generated for a comparison. In order to obtain an S-random interleaver with a maximum S value, it is started with a relatively small S value and then S is increased if a generation is successful. This operation continues until the generation is impossible. As a next operation, the S-random interleaver with S=16. is obtained.

For a generation of a modified linear congruence interleaver, P=17 is chosen which is a relative prime to L=512 in the vicinity of the S value found in the S-random interleaver. Q=4 is fixed. Therefore, with a given. P, Q and L, the algorithm in the aforementioned paper generates 12,582,912 feasible interleavers, for example. Considering the full parameter combinations (512⁶), reducing the parameter search space can be considered. In the example generation, D₀=0 is fixed. Without a fixed. D₀, the algorithm can generate. L=512 number of globally circular shifted interleavers. In other words, the algorithm produces L number of parameter sets {(D₀+i, . . . , D_{Q-1}+i)|i=0, . . . , L−1) With the tail-biting encoding, their cycle distributions are typically identical. Therefore, with D₀=0, feasible interleavers having only distinct cycle distributions can be generated. For example, three (3) candidates of parametric interleavers are taken, which are summarized in the below Table 1. In the Table 1, t_{depth} is the averaged value over all support trees having L different nodes as roots.

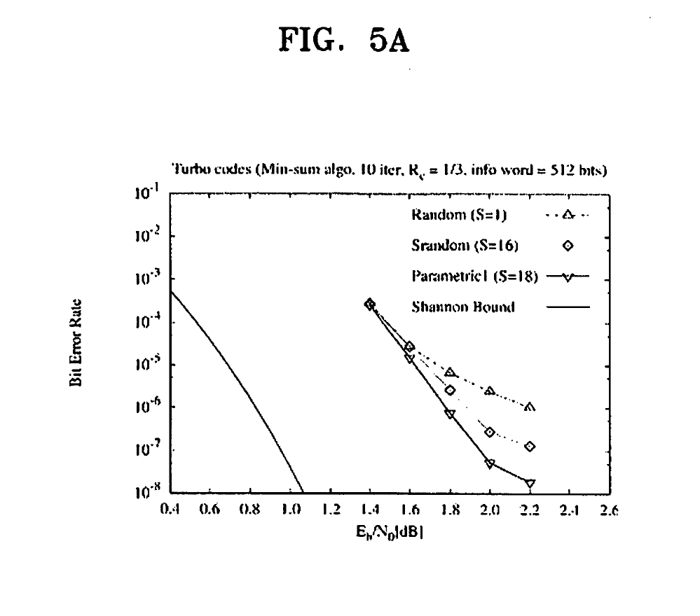

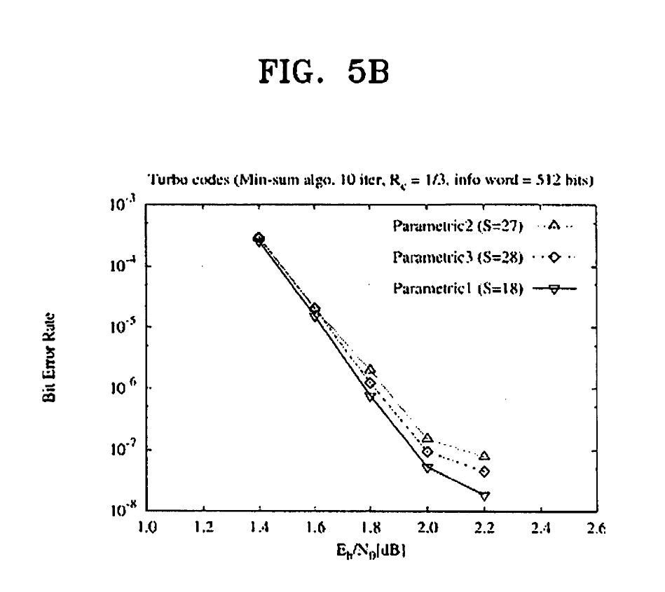

The simulation results of S-random, parametric 1 and randomly generated interleavers are shown in FIG. 5A. The sphere-packing lower bound with the code length of 512 bits and the rate R_{c} of 1/3 are also shown (reference material: S. Dolinar, D. Divsalar, and F. Pollara, “Code performance as a function of block size,” in TMO Progress Report, ser. 42.1 em plus 0.5 em minus 0.4 em JPL, May 1998, vol. 133, pp. 1-23, the disclosure of which is incorporated herein by reference). In this regard, it is a theoretical code performance bound with a finite code length. As illustrated in FIG. 5A, the parametric interleaver typically performs better than the S-random interleaver, with codes that are less than 1.0 decibel (dB) with respect to E_{b}/Nₒ (the energy per bit noise power spectral density to signal to noise ratio per bit) apart from the bound at a bit error rate (BER)=10⁻⁶ indicates a relatively good optimality.

FIG. 5B shows examples of the performance difference among parametric interleavers. From FIG. 5B, it can be observed that a high S value does not necessarily mean better performance. In this regard, too high S values can reinforce a regular structure in an interleaver and can provide a bad effect. It is a typically good rule of thumb to have an S value slightly over \sqrt{L/2}, as explained in (reference material: S. Dolinar and D. Divsalar, “Weight distributions for turbo codes using random and nonrandom permutations,” in TDA Progress Report, ser. 42.1 em plus 0.5 em minus 0.4 em JPL, August 1995, vol. 122, pp. 56-65, the disclosure of which is incorporated herein by reference), where the reference material suggests an S value is less than \sqrt{L/2}.

TABLE 1

| Types | S | t_{depth} | D₁ | D₂ | D₃ |
|---|---|---|---|---|---|
| S-random | 16 | 2.9 | | | |
| Parametric 1 | 18 | 3.0 | 9 | 87 | 432 |
| Parametric 2 | 27 | 3.0 | 398 | 219 | 175 |
| Parametric 3 | 28 | 3.0 | 270 | 219 | 491 |

Aspects and embodiments of the invention provide a modified linear congruence interleaver, and provide a parameter selection method, wherein a geometric algorithm generates feasible interleavers in most practical cases. Since the proposed interleaver, according to aspects of the invention, can take a simple and generic form, the invention has applicability to many real world applications that require or utilize variable frame sizes. The parametric interleaver, according to aspects of the invention has applicability, for example, to Turbo codes, such as those used in Digital Video Broadcast—Return Channel Satellite (DVB-RCS) codes, although the invention is not limited in this regard. As described, a parameter selection method and a linear congruence interleaver, according to example embodiments and aspects of the invention, generates the feasible cases for a linear congruence interleaver to apply to an iterative decoder circuit in a transmission and/or a communication system so as to promote a significant reduction in the required time to search an optimized interleaver.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A parameter selection method of a linear congruence interleaver to interleave input data by k linear equations, the method comprising:
determining a placement zone specified by index values;
determining position values (i₁, i₂) of groups of data including a number of index values in the placement zone; and
determining a parameter value Dₖ for use in an interleaving operation of the input data based on the following equation: Dₖ=P(Qi₁+i₂−k)(mod L), wherein
L indicates a length of the data to interleave,
Q indicates the number of linear congruence equations,
k has a value in a range of 1 through Q−1,
P indicates a parameter, with P and L being relatively prime to each other in a relation of a greatest common divisor (gcd) (P, L), and
i indicates an index value of input data corresponding to the position values (i₁, i₂).

2. The method as claimed in claim 1, wherein the determining position values (i₁, i₂) of groups of the data including corresponding index values among the generated index values in the placement zone comprises:
determining a respective number and a respective length of the groups of the data;
forming groups of the data corresponding to the respective number and the respective length in the placement zone; and
determining the position values (i₁, i₂) for the groups of the data.

3. A linear congruence interleaver to interleave input data by k linear equations comprising:
a placement determiner to determine a placement zone specified by index values;
a position value determiner to determine position values (i₁, i₂) of groups of data including a number of index values in the placement zone; and
a parameter selector to determine a parameter value Dₖ for use in an interleaving operation of the input data, based on the following equation: Dₖ=P(Qi₁+i₂−k)(mod L), wherein
L indicates a length of the data to interleave,
Q indicates the number of linear congruence equations,
k has a value in a range of 1 through Q−1,
P indicates a parameter, with P and L being relatively prime to each other in a relation of a greatest common divisor (gcd) (P, L), and
i indicates an index value of input data corresponding to the position values (i₁, i₂); and
an interleaving unit to interleave the input data by the k linear equations using the determined parameter value Dₖ.

4. The linear congruence interleaver as claimed in claim 3, wherein:
the position value determiner determines a respective number and a respective length of the groups of the data, forms groups of the data corresponding to the respective number and the respective length in the placement zone, and determines the position values (i₁, i₂) for the groups of the data.

5. The linear congruence interleaver as claimed in claim 4, wherein:
the placement determiner determines the placement zone specified by index values generated by an algorithm.

6. The linear congruence interleaver as claimed in claim 4, wherein:
the linear congruence interleaver determines optimized parameters to provide an optimized interleaver to apply to an iterative decoder.

7. The linear congruence interleaver as claimed in claim 4, wherein:
the interleaving unit interleaves the input data by the k linear equations using the determined parameter value Dₖ to provide an optimized interleaver to apply to an iterative decoder.

8. The linear congruence interleaver as claimed in claim 4, wherein:
the interleaving unit interleaves the input data by the k linear equations using the determined parameter value Dₖ to provide an optimized interleaver to reduce the time to search the optimized interleaver.

9. The linear congruence interleaver as claimed in claim 3, wherein:
the placement determiner determines the placement zone specified by index values generated by an algorithm.

10. The linear congruence interleaver as claimed in claim 3, wherein:
the linear congruence interleaver determines optimized parameters to provide an optimized interleaver to apply to an iterative decoder.

11. The linear congruence interleaver as claimed in claim 3, wherein:
the interleaving unit interleaves the input data by the k linear equations using the determined parameter value Dₖ to provide an optimized interleaver to apply to an iterative decoder.

12. The linear congruence interleaver as claimed in claim 3, wherein:
the interleaving unit interleaves the input data by the k linear equations using the determined parameter value Dₖ to provide an optimized interleaver to reduce the time to search the optimized interleaver.

13. The method as claimed in claim 2, further comprising:
generating the index values by an algorithm to determine the placement zone specified by the index values.

14. The method as claimed in claim 2, further comprising:
determining optimized parameters to provide an optimized interleaver to apply to an iterative decoder.

15. The method as claimed in claim 2, further comprising:
interleaving the input data by the k linear equations using the determined parameter value Dₖ to provide an optimized interleaver to apply to an iterative decoder.

16. The method as claimed in claim 2, further comprising:
interleaving the input data by the k linear equations using the determined parameter value Dₖ to provide an optimized interleaver to reduce the time to search the optimized interleaver.

17. The method as claimed in claim 1, further comprising:
generating the index values by an algorithm to determine the placement zone specified by the index values.

18. The method as claimed in claim 1, further comprising:
determining optimized parameters to provide an optimized interleaver to apply to an iterative decoder.

19. The method as claimed in claim 1, further comprising:
interleaving the input data by the k linear equations using the determined parameter value Dₖ to provide an optimized interleaver to apply to an iterative decoder.

20. The method as claimed in claim 1, further comprising:
interleaving the input data by the k linear equations using the determined parameter value Dₖ to provide an optimized interleaver to reduce the time to search the optimized interleaver.

21. A transmission method, comprising:
interleaving input data based on a parameter, the parameter being selected by:
determining a placement zone specified by index values;
determining position values (i₁, i₂) of groups of data including a number of index values in the placement zone; and
determining a parameter value Dₖ for use in an interleaving operation of the input data based on the following equation: Dₖ=P(Qi₁+i₂−k)(mod L), wherein
L indicates a length of the data to interleave,
Q indicates the number of linear congruence equations,
k indicates a number of linear equations and has a value in a range of 1 through Q−1,
P indicates a parameter, with P and L being relatively prime to each other in a relation of a greatest common divisor (gcd) (P, L), and
i indicates an index value of input data corresponding to the position values (i₁, i₂); and
transmitting interleaved data via a transmission channel.

22. The transmission method as claimed in claim 21, wherein the determining position values (i₁, i₂) of groups of the data including a number of index values in the placement zone comprises:
determining a respective number and a respective length of the groups of the data;
forming groups of the data corresponding to the respective number and the respective length in the placement zone; and
determining the position values (i₁, i₂) for the groups of the data.

23. The transmission method as claimed in claim 22, wherein the transmitting the interleaved data by the transmitter to a receiver comprises:
transmitting the interleaved data to a receiver comprising an iterative decoder.

24. The transmission method as claimed in claim 21, wherein the transmitting the interleaved data by the transmitter to a receiver comprises:
transmitting the interleaved data to a receiver comprising an iterative decoder.

25. A computer-readable recording medium having embodied thereon a computer program to execute by a processor a parameter selection method of a linear congruence interleaver to interleave input data by k linear equations, the method embodied in the program comprising:
determining a placement zone specified by index values;
determining position values (i₁, i₂) of groups of data including a number of index values in the placement zone; and
determining a parameter value Dₖ for use in an interleaving operation of the input data based on the following equation: Dₖ=P(Qi₁+i₂−k)(mod L), wherein
L indicates a length of the data to interleave,
Q indicates the number of linear congruence equations,
k has a value in a range of 1 through Q−1,
P indicates a parameter, with P and L being relatively prime to each other in a relation of a greatest common divisor (gcd) (P, L), and
i indicates an index value of input data corresponding to the position values (i₁, i₂).

26. The computer-readable recording medium as claimed in claim 25, wherein in the method embodied in the program the determining position values (i₁, i₂) of groups of data including a number of index values in the placement zone comprises:
determining a respective number and a respective length of the groups of the data;
forming groups of the data corresponding to the respective number and the respective length in the placement zone; and
determining the position values (i₁, i₂) for the groups of the data.

27. A linear congruence interleaver, comprising:
a linear congruence interleaver to interleave input data for use in an interleaving operation of the input data, based on the following equation: pi(i)=(P*i+D_{i mod Q}) mod L, wherein L is the interleaving length, and P, D_0, . . . , D_{Q−1} are the integer parameters.

28. The linear congruence interleaver as claimed in claim 27, wherein:
in the equation pi(i)=(P*i+D_(i mod Q))mod L, the i-th symbol in the input block of the data is placed in the pi(i)-th symbol in the interleaved block of the data.

29. A parameter selection method of a linear congruence interleaver, comprising:
interleaving input data by a linear congruence interleaver for use in an interleaving operation, based on the following equation: pi(i)=(P*i+D_(i mod Q}) mod L, wherein L is the interleaving length, and P, D_0, . . . , D_{Q−1} are the integer parameters.

30. The method as claimed in claim 29, wherein:
in the equation pi(i)=(P*i+D_i mod Q))mod L, the i-th symbol in the input block of the data is placed in the pi(i)-th symbol in the interleaved block of the data.

31. A computer-readable recording medium having embodied thereon a computer program to execute by a processor a parameter selection method of a linear congruence interleaver, the method embodied in the program comprising:
interleaving input data by a linear congruence interleaver for use in an interleaving operation, based on the following equation: pi(i)=(P*i+D_{i mod Q}) mod L, wherein L is the interleaving length, and P, D_0, . . . , D_{Q−1} are the integer parameters.

32. The computer-readable recording medium as claimed in claim 31, wherein in the method embodied in the program, in the equation pi(i)=(P*i+D_(i mod Q))mod L, the i-th symbol in the input block of the data is placed in the pi(i)-th symbol in the interleaved block of the data.
